(19) United States
(12) Patent Application Publication
(10) Pub. No.: US 2006/0145971 A1
(43) Pub. Date: Jul. 6, 2006

(54) Turn-over structure of multimedia device

(76) Inventors: Chen-Kuang Yeh, Taipei City (TW); Chih-Hsiang Tsai, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/024,716

(22) Filed: Dec. 30, 2004

(51) Int. Cl. G09G 3/32

(52) U.S. Cl. 345/82

(57) ABSTRACT

A turn-over structure of a multimedia device for connecting a host and a screen which prevents the screen from tilting downward comprising; a holder, a first spindle and a second spindle. The holder is penetrated vertically forming a first opening and is penetrated laterally forming a second opening, the second opening is connected to a part of an outer rim of the first opening; the first spindle is rotatably disposed in the first opening, the first spindle is formed with a pair of curvy grooves opposite each other, the curvy grooves are disposed on the intersection of the first and second openings, in which one of the curvy grooves is engaged with the second spindle; and the second spindle is rotatably disposed in the second opening, the bottom of the second spindle is formed with a curvy groove on the intersection of the first opening and the second opening.

### BACKGROUND OF THE INVENTION

1. Field of the Invention

The present invention relates to a turn-over structure of a multimedia device, in particular to a turn-over structure connected to a screen and a host of other multimedia devices, and in particular to the screen of a multimedia product which is rotatable along two axes, which are perpendicular to each other.

2. Description of Related Art

Multimedia devices, like digital cameras, digital video cameras or multimedia players, need a small turn-over structure for connecting the screen to the host, such that the screen is rotatable in various directions. Different multimedia devices have different turn-over structures. Please refer to FIGS. 1 and 2, which are three-dimensional diagrams that show the known multimedia devices which have screens with different spreading angles. For convenience, one of the screens provides an operation mode which makes the screen turn-over in direction of two axes perpendicular to each other so that the user can operate the multimedia device easily at various viewpoints. The multimedia device 9 has a screen 92 connected to a host 94, and the screen 92 can be longitudinally turned-over along a longitudinal axis A-A and be traverse turned-over along a traverse axis B-B. Referring to FIG. 2 when the screen 92 of the known multimedia device 9 is turned to face the user, the weight of screen 92 causes the screen 92 to tilt downward, which is shown as arrow C in FIG. 2. The turn-over structure of prior art usually use a sleeve to clamp the longitudinal axis A-A tightly, so that preventing the screen 92 from tilting downwardly via the friction. However, the turn-over structure with tightly clamping inevitably generates mass friction. After the screen 92 has been turned over a number of times, the inner part of the turn-over structure is easily broken and the structure becomes loose. This result will affect the operating-quality of the multimedia and reduce its user life.

Besides, screens of the known multimedia devices need to be in a particular position for fixing, such as the one seen in the vertical-view of FIG. 2. The turn-over structure of the prior art uses two ring-shape metal gaskets and the corresponding protrusion and recess are respectively disposed at specific angles; the turn-over structure is fixed in a predetermined position by the engagement of the protrusion and the recess.

However, the metal gaskets of the above, turn-over structure, and especially the profile of the protrusion, have the drawback of being easily rubbed off, thus causing the disappearance of the fix-function and a deterioration in operating-quality.

Moreover, the turn-over structure of the multimedia device comprises a soft bus (FFC, Flexible Flat Cable) for connecting the power source and signals. The soft bus is required to be hidden in the turn-over structure and to be wound for lengthening and shortening while rotating. The soft bus is usually passed through the turn-over structure and then wound in the inward thereof. However, the small size of the turn-over structure causes inconvenience in winding the soft bus and is difficult to assembly.

Given the above, the turn-over structure of multimedia devices of the prior art obviously have a number of inconveniences and drawbacks in practical use and need improving.

Consequently, because of the technical defects described above, the applicant keeps on carving unflaggingly through wholehearted experience and research to develop the present invention, which can effectively improve the defects described above.

### SUMMARY OF THE INVENTION

The objective of the present invention provides a turn-over structure of a multimedia device which can make the screen thereof fix without sliding down while being spread to a vertical position. Another objective of the present invention provides a turn-over structure of a multimedia device having a rub-resistant fixing-structure for reducing the rub-off and increasing the reliability of fixing so as to extend its user life thereof.

Another objective of the present invention provides a turn-over structure of a multimedia device, wherein the soft bus is wound first and then inserted into the turn-over structure for simplifying the assembly of the soft bus.

To achieve the above objectives, the turn-over structure of the multimedia device of the present invention comprises a holder that is vertically penetrated to form a first opening and is laterally penetrated to form a second opening, the second opening is connected to a part of an outer rim of the first opening; a first spindle that is rotatably disposed in the first opening, the bottom thereof is connected to the screen, the first spindle is formed with a pair of curvy grooves opposite each other, the pair of curvy grooves are disposed on the intersection of the first opening and the second opening, in which one of the curvy grooves are engaged with the second spindle; and a second spindle that is rotatably disposed in the second opening, two ends thereof are connected to the host, the bottom of the second spindle is formed with a curvy groove on the intersection of the first opening and the second opening.

The detail description and drawings are disclosed below for facilitating the examiner to further understand the technical features and contents of the present invention. However, the appended drawings are merely provided as references and illustrations, not to limit the scope of the present invention.

### BRIEF DESCRIPTION OF THE DRAWINGS

FIG. 1 is a three-dimensional diagram that shows the traverse spread of the screen of the multimedia device in the prior art;

FIG. 2 is a three-dimensional diagram that shows the screen of the multimedia device in the prior art after it has been turned to face the user;

FIG. 3 is a three-dimensional explosion diagram that shows the turn-over structure of the multimedia device of the present invention;

FIG. 4 is a three-dimensional assembly diagram that shows the turn-over structure of the multimedia device of the present invention;

FIG. 5 is a lateral view of the assembly of the turn-over structure of the multimedia device of the present invention;

FIG. 6 is a lateral view of the assembly of the first spindle and the second spindle;

FIG. 7 is a lateral view of the assembly of the first spindle and the second spindle at another angle;

FIG. 8 is a vertical view of the assembly of the turn-over structure of the multimedia device of the present invention;

FIG. 9 is a top view of buses of the turn-over structure of the multimedia device of the present invention; and

FIG. 10 is a perspective assembled view of buses of the turn-over structure of the multimedia device of the present invention.

### DETAILED DESCRIPTION OF THE PREFERRED EMBODIMENTS

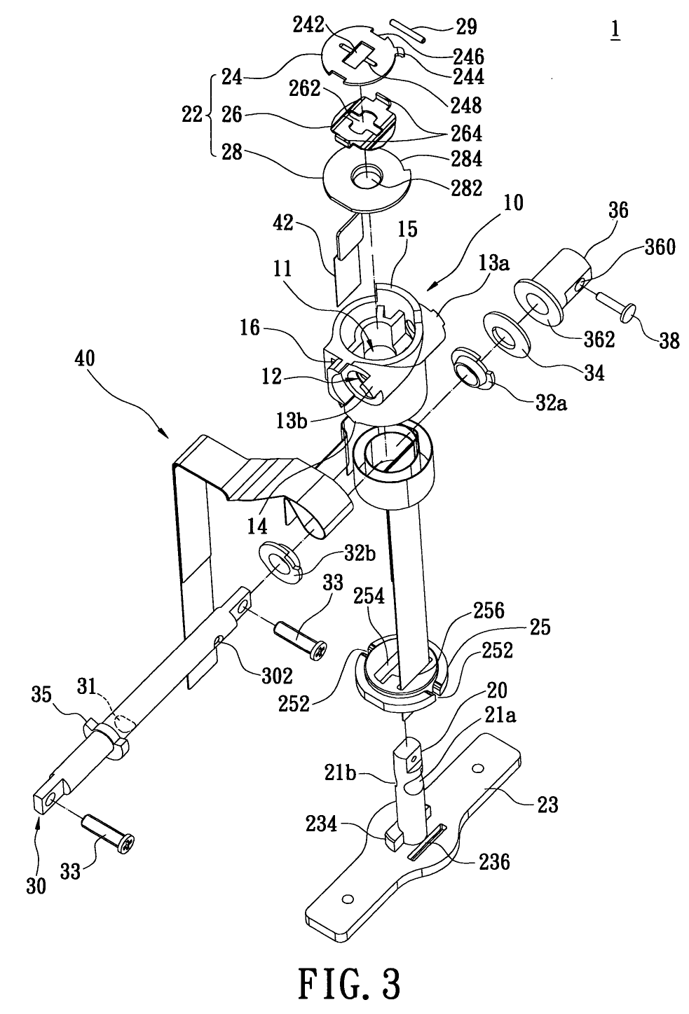

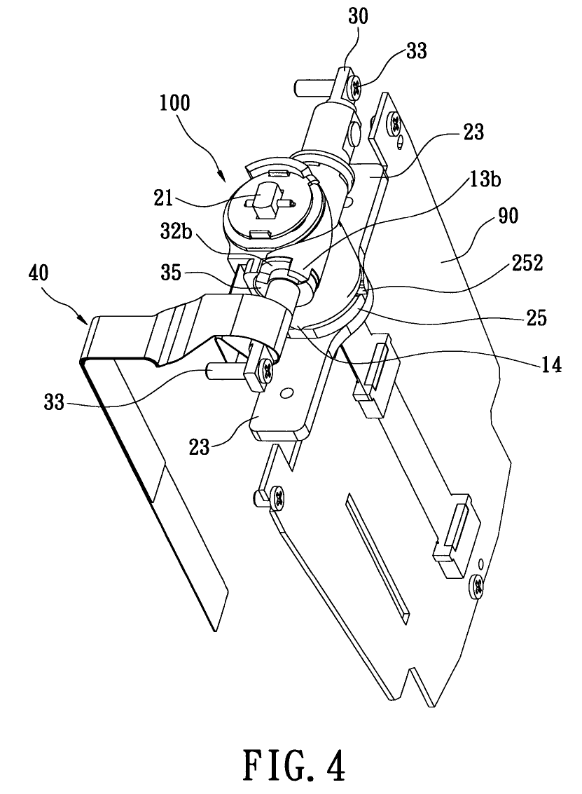

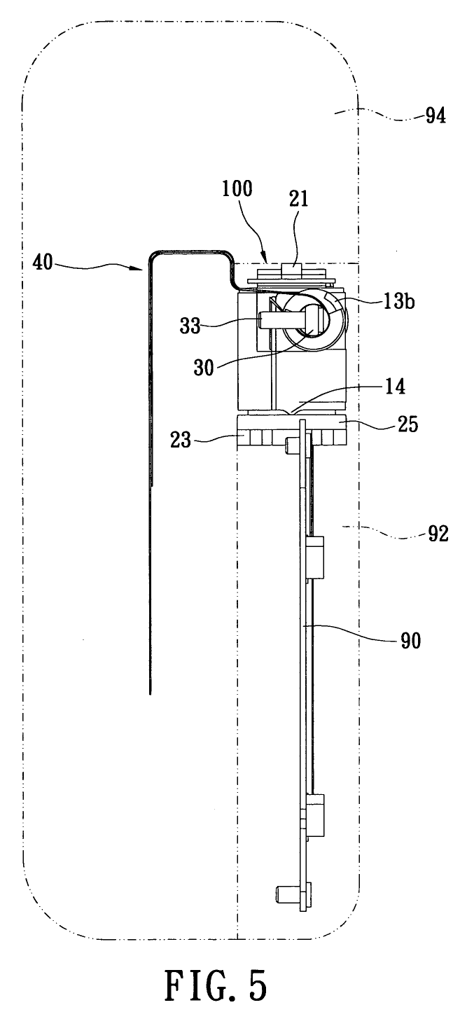

Please refer to FIG. 3 to FIG. 5, which are respectively a three-dimensional explosion diagram, a three-dimensional assembly diagram and a lateral view of the assembly of the turn-over structure of a multimedia device of the present invention. A turn-over structure 1 of a multimedia device of the present invention for connecting the host and screen of a multimedia device comprises a holder 10, a first spindle 20 which is connected to an end of the screen 92, a second spindle 30 which is fixed onto the host 94, and a pair of buses 40 that are electrically connected to the host 94 and a circuit board 90 which is disposed in the screen 92 for transmitting power and signals.

The holder 10 is a shaped somewhat similar to that of a cylinder, the center port thereof is vertically penetrated to form a first opening 1, the circumference portion thereof protrudes toward two sides with a pipe-wall to form a second opening 12 which is laterally penetrated; wherein the second opening 12 is connected to a part of the circumference of the first opening 11.

The first spindle 20 is a spindle, preferably a metal spindle. The first spindle 20 is rotatably disposed in the first opening 11, and the bottom thereof is connected to the screen 92. The first spindle 20 is formed with a pair of curvy grooves 21a and 21b opposite to each other, the pair of curvy grooves 21a and 21b are disposed on the intersection of the first opening 11 and the second opening 12, in which the curvy groove 21b is engaged with the second spindle 30.

The second spindle 30 is a spindle, preferably a metal spindle. The second spindle 30 is rotatably disposed in the second opening 12, two ends thereof are fixed to the host 94 by screws 33. The bottom of the second spindle 30 is formed with a curvy groove 31 on the intersection of the first opening 11 and the second opening 12.

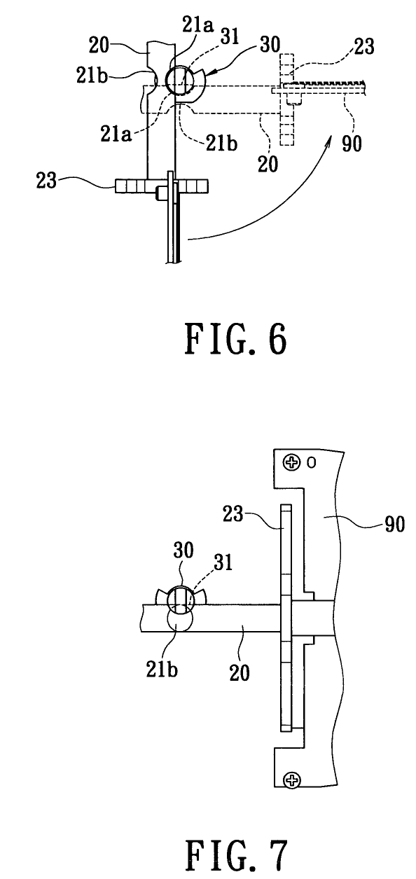

Please refer to FIG. 6 and FIG. 7, which are lateral views of the assembly of the first spindle and the second spindle. When the screen 92 is turned to a side, the curvy groove 21a of the first spindle 20 smoothly moves along a surface of the second spindle 30 to the downward of the curvy groove 31 of the second spindle 30.

When the first spindle 20 is turned to 45 degrees, the curvy groove 21a of the first spindle 20 is engaged with the curvy groove 31 of the second spindle 30, so that the first spindle 20 is not rotatable. In other word, the screen 92 has a function of self-lock so as to prevent the screen 92 from turning towards the front or back at 45 degrees and breaking the screen 92.

When the first spindle 20 is turned horizontally, the curvy groove 21a of the first spindle 20 is positioned under the curvy groove 31 of the second spindle 30, and the first spindle 20 is rotatable. Referring to FIG. 7, the first spindle 20 is self-turned with 90 degrees, i.e. the screen 92 is in a vertical mode in which the screen 92 faces the user. At this time, the horizontal walls of the first spindle 20, which are between the pair of curvy grooves 21a and 21b, are clamped by the holder 10, and abutted against the inner wall of the curvy groove 31 of the second spindle 30. Thereby the screen 92 is supported by the top surface of the first spindle 20 without sliding down.

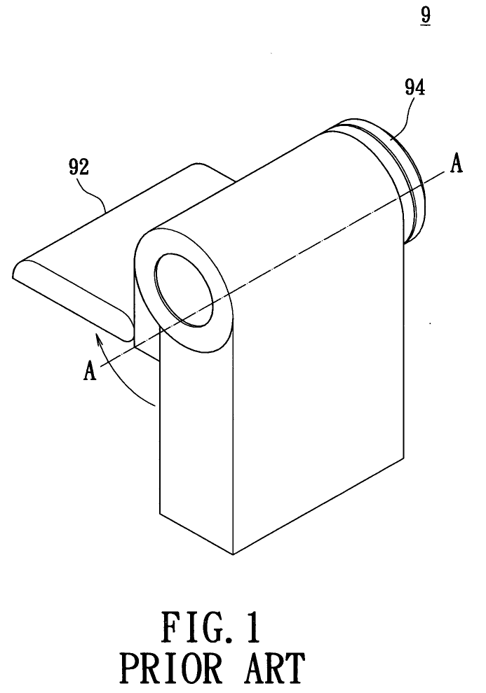

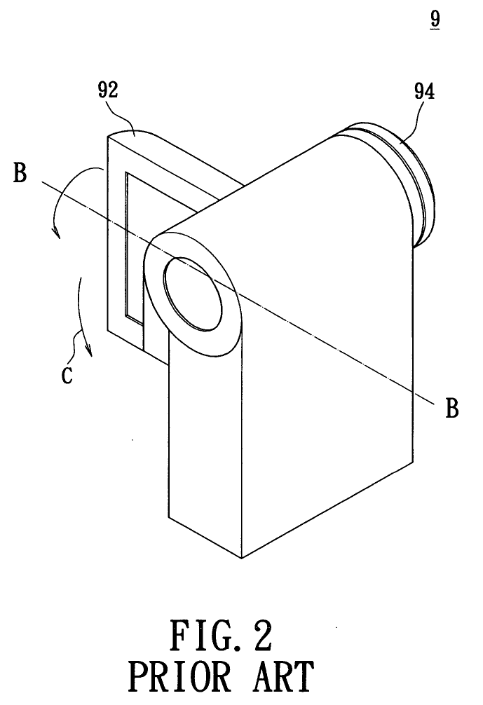

Referring once again to FIG. 1 to FIG. 3, in order to facilitate the smooth rotation of the second spindle 30, the present invention comprises a pair of spindle-rings 32a and 32b which are respectively fixed on two ends of the second opening 12 of the holder 10, wherein the second spindle 30 is inserted into the pair of spindle-rings 32a and 32b. The pair of spindle-rings 32a and 32b of the present invention are made of rub-resistant plastic, which have a inner ring engaged tightly in the second opening 12. The inner ring has a smooth inner surface for providing smooth rotation to the second spindle 30. Each of the spindle-rings 32a and 32b has a plane outer surface. For fixing the pair of spindle-rings 32a and 32b to the holder 10, the circumferential wall of the holder 10 is disposed with a front protrusion 13a and a rear protrusion 13b. Each of the outer edges of the spindle-rings 32a and 32b are respectively disposed with a recess corresponding to the front protrusion 13a and the rear protrusion 13b.

The second spindle 30 further comprises an elastic gasket 34, a sleeve 36 and a fix-bolt 38. The elastic gasket 34 preferably is made of metal and appears in a little indentation-shape. The elastic gasket 34 is disposed on the front of the second spindle 30 and abuts against the spindle-ring 32a set in front of the elastic gasket 34. The sleeve 36 is disposed on the front end of the elastic gasket 34, and has a plane bottom 362 to abut against the elastic gasket 34. To fix the sleeve 36 to the second spindle 30, the fix-bolt 38 is inserted through an insertion hole 360 on the side of the sleeve 36 and an insertion hole 302 of the second spindle 30.

For controlling the rotative angles of the second spindle 30, the second spindle 30 comprises a fix-ring 35 which is disposed on the rear end thereof and abuts against the spindle-ring 32b set in back of the fix-ring 35. The fix-ring 35 is formed with a sectorial groove with a predetermined angle, in which the rear protrusion 13b of the holder 10 is extended, and the rear protrusion 13b can block the fix-ring 35. The second spindle 30 of the present invention can be turned to 90 degrees, i.e. if the angle of the rear protrusion 13b is subtracted from the angle of the sectorial ring the result should be 90 degrees. The first spindle 20 of the present invention can be turned to a position at a specific angle. To overcome the drawbacks of known technology that the rotation and fixing members are easily rubbed off, the bottom rim of the holder 10 of the present invention is protruded with a pair of fix-protrusions 14 opposite each other. The bottom of the first spindle 20 has a bottom-plate 23 and a fix-gasket 25 mounted to the top surface of the bottom-plate 23. The fix-gasket 25 abuts against the bottom of the holder 10 and is formed with a pair of fix-indentations 252. The first spindle 20 rotates and drives the fix-gasket 25 so that the fix-protrusions 14 of the holder 10 are inserted into the fix-indentation 252 at a predetermined angle. In this embodiment, the predetermined angle can be 90 degrees and 270 degrees. For fixing the fix-gasket 25 to the bottom-plate 23, the bottom-plate 23 of the first spindle 20 comprises a protrudent engagement-block 234, and the fix-gasket 25 is formed with a first engagement-groove 254 corresponding to the engagement-block 234.

The top of the first spindle 20 is mounted with a rotatable fix-member 22 which can be rotatably disposed on the top of the holder 10 for fixing the first spindle 20 in the holder 10, wherein the first spindle 20 can be turned smoothly. The rotatable fix-member 22 comprises a rotatable fix-piece 24, a blade spring 26, a cover-ring 28 and a bolt 29. The cover-ring 28 is made of rub-resistant plastic and is disposed on the top of the holder 10. The blade spring 26 is made of metal foil and abuts against the top surface of the cover-ring 28 for clamping the fix-gasket 25 onto the holder 10. The rotatable fix-piece 24 is fixed to the top surface of the blade spring 26 for controlling the rotative angle of the first spindle 20. The top of the first spindle 20 sequentially passes through the rotatable fix-piece 24, the blade spring 26, the center holes 242, 262, 282 of the cover-ring 28, and then the bolt 29 fixes the top of the first spindle 20 to the rotatable fix-piece 24.

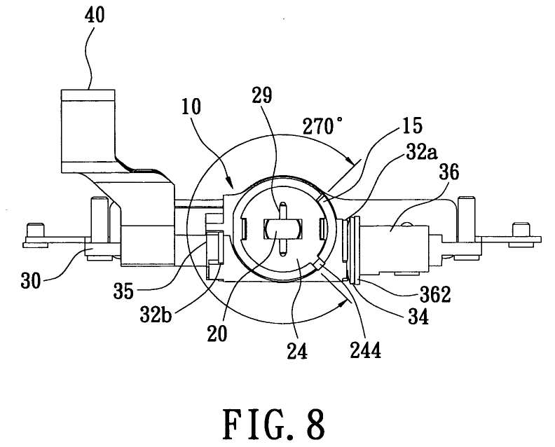

For controlling the range of the rotating angle while the first spindle 20 is turning horizontally, the rotatable fix-piece 24 has a fix-protrudent-piece 244 extending outwardly from the circumferences thereof, a pair of indentations 246 inwardly recessed from the circumferences thereof, and a sunken-portion 248 disposed on the top surface thereof. The outer rim of the blade spring 26 has a pair of ears 264 which are protruded upwardly and fixed to the pair of indentations 246, and the bolt 29 is disposed in the sunken-portion 248. The top rim of the holder 10 has a protrudent wall 15 and the cover ring 28 is formed with an engagement-groove 284 corresponding to the protrudent wall 15. Referring simultaneously to FIG. 8, the fix-protrudent-piece 244 is slid between two ends of the protrudent wall 15, and the rotation range of the first spindle 20 of the present invention is 270 degrees.

The present invention is directed to overcoming inconvenience while assembling the soft bus of the prior art, wherein the holder 10 has a groove 16 with a predetermined length and an accommodation space on the bottom and the groove 16 is upwardly disposed from the bottom rim thereof. The bus 40 of the present invention is wound and directly upwardly disposed in the groove 16 and accommodation space of the holder 10. The present invention further comprises a twin adhesive 42 which fixes the bus 40 to the inner wall of the holder 10 for preventing the bus 40 from deviation of rotation. One end of the bus 40 passes through a bus channel 236 of the bottom-plate 23 of the first spindle 20 and a bus channel 256 of the fix-gasket 25 for connecting to the circuit board 90 in the screen 92. The other end of the bus 40 is outwardly extended from the holder 10 and wound on the second spindle 30 for connecting to the host 94.

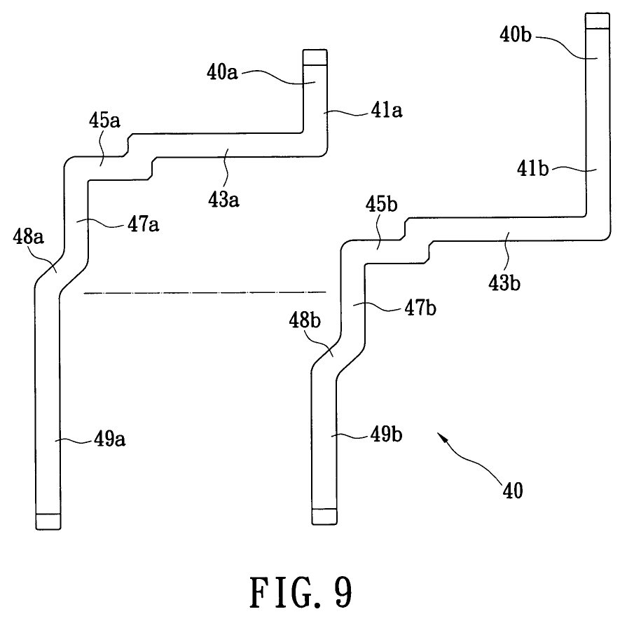

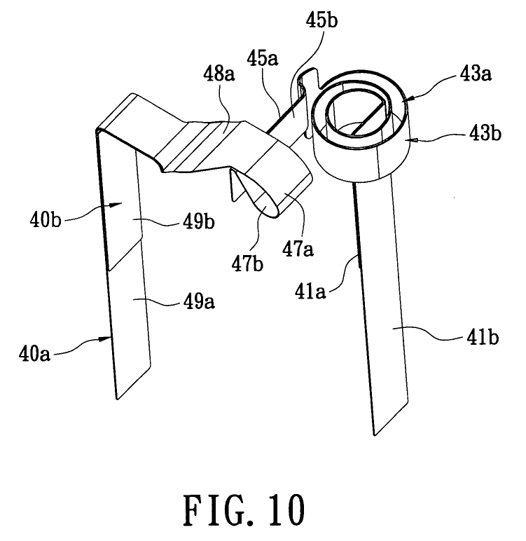

Referring to FIGS. 9 and 10, the buses 40 are consisted of a first bus 40a, and a second bus 40b. The first bus 40a and the second bus 40b substantially are overlapped to each other. Each of the buses has a first connecting section 41a, 41b, a flexible rolling section 43a, 43b, an extending section 45a, 45b, a mounting section 47a, 47b, and a second connecting section 49a, 49b. In this embodiment, the first connecting section 41a, 41b pass through the bottom plate 23 and the fix-gasket 25, and connect with the circuit board 90. The rolling section 43a, 43b is received in the holder 10. The mounting section 47a, 47b is wrapped around the second spindle 30. The mounting section 47a, 47b and the second connecting section 49a, 49b are connected by a titled section 48a, 48b. The second connecting section 49a, 49b is connected with the host 94. The buses 40 have a firm structure that can avoid from be rubbed and are durable.

[Features and Characteristics of the Present Invention]

In conclusion, the present invention has the following characteristics and functions:

1. The first spindle 20 and second spindle 30 of the present invention cooperate with each other so as to replace the tight clamping of the prior art. The screen 92 has a self-locking function to prevent the screen 92 from turning frontward or backwards at 45 degrees thus preventing the screen from sliding down while turning to face the user.

2. The rotatable fix-member of the present invention consists of rub-resistant plastic for overcoming the drawbacks of that the prior art in which the rotation and fixing members are easily rubbed off.

3. The holder 10 of the present invention has a groove and an accommodation space that provides a structure for conveniently assembling the soft bus overcoming the inconveniences experienced while assembling the soft bus in the prior art.

While the invention has been described in terms of what is presently considered to be the most practical and preferred embodiments, it is to be understood that the invention should not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A turn-over structure of a multimedia device for connecting a host and a screen, said structure comprising:
a holder being vertically penetrated to form a first opening and being laterally penetrated to form a second opening, the second opening being connected to a part of an outer rim of the first opening;
a first spindle being rotatably disposed in the first opening, the bottom thereof being connected to the screen, the first spindle being formed with a pair of curvy grooves opposite each other, the pair of curvy grooves being disposed on the intersection of the first opening and the second opening, in which one of the curvy grooves is contacted with the second spindle; and
a second spindle being rotatably disposed in the second opening, the two ends thereof being connected to the host, the bottom of the second spindle being formed with a curvy groove on the intersection of the first opening and the second opening.

2. The turn-over structure of the multimedia device of claim 1, further comprises a pair of spindle-rings which are respectively fixed on two ends of the second opening of the holder, wherein the second spindle is inserted into the pair of spindle-rings.

3. The turn-over structure of the multimedia device of claim 2, wherein the outer rim of the holder is disposed with a front protrusion and a rear protrusion, the outer rims of spindle-rings corresponding to the front and rear protrusions are respectively disposed with a recess, and the spindle-rings are tightly engaged with two ends of the second spindle.

4. The turn-over structure of the multimedia device of claim 2, wherein the second spindle comprises an elastic gasket which is disposed on the front thereof and abutted against the spindle-ring set in front of the elastic gasket, a sleeve is disposed on the front end of the elastic gasket, and a fix-bolt for fixing the sleeve to the second spindle.

5. The turn-over structure of the multimedia device of claim 2, wherein the second spindle comprises a fix-ring which is disposed on the rear end thereof and abutted against the spindle-ring set in back of the fix-ring, and the second spindle is disposed with a sectorial groove with a predetermined angle, in which the rear protrusion of the holder is extended.

6. The turn-over structure of the multimedia device of claim 1, wherein the bottom rim of the holder is disposed with a pair of fix-protrusions opposite each other, the bottom of the first spindle is disposed with a fix-gasket which abuts against the bottom of the holder and is formed with a pair of fix-indentation.

7. The turn-over structure of the multimedia device of claim 6, wherein the bottom of the first spindle is mounted with a bottom-plate, and the fix-gasket is mounted to the top surface of the bottom-plate.

8. The turn-over structure of the multimedia device of claim 7, wherein the bottom-plate of the first spindle comprises a protrudent engagement-block and the fix-gasket is disposed with a first engagement-groove corresponding to the engagement-block.

9. The turn-over structure of the multimedia device of claim 1, wherein the top of the first spindle is disposed with a rotatable fix-member which can be rotatably disposed on the top of the holder.

10. The turn-over structure of the multimedia device of claim 9, wherein the rotatable fix-member comprises a cover-ring disposed on the top of the holder, a blade spring abuts against the top surface of the cover-ring, a rotatable fix-piece which is fixed to the top surface of the blade spring, and a bolt which fixes the top of the first spindle to the rotatable fix-piece.

11. The turn-over structure of the multimedia device of claim 10, wherein the rotatable fix-piece has a fix-protrudent-piece extending outwardly from the circumferences thereof, a pair of indentations inwardly recessed from the circumferences thereof, and a sunken-portion disposed on the top surface thereof, wherein the outer rim of the blade spring has a pair of ears which are protruded upwardly and fixed to the pair of indentation, and the bolt is disposed in the sunken-portion.

12. The turn-over structure of the multimedia device of claim 10, wherein the top rim of the holder has a protrudent wall and the cover ring is disposed with an engagement-groove corresponding to the protrudent wall.

13. The turn-over structure of the multimedia device of claim 1, wherein the holder has a groove with a predetermined length and an accommodation space on the bottom and the groove is upwardly disposed from the bottom rim thereof.

14. The turn-over structure of the multimedia device of claim 13, further comprises a pair of bus which are wound and upwardly disposed in the groove and accommodation space of the holder.

15. The turn-over structure of the multimedia device of claim 14, further comprises a twin adhesive which mounts the bus to an inner wall of the holder.

16. The turn-over structure of a multimedia device of claim 14, wherein the bus passes through a bus channel disposed in the bottom-plate of the first spindle and a bus channel disposed in the fix-gasket.

17. The turn-over structure of a multimedia device of claim 14, wherein the bus is outwardly extended from the holder and wound on the second spindle.

18. The turn-over structure of a multimedia device of claim 14, wherein each of the buses has a first connecting section, a flexible rolling section, an extending section, a mounting section, and a second connecting section.

19. The turn-over structure of a multimedia device of claim 18, wherein the first connecting section pass through the bottom plate and the fix-gasket, and connect with the circuit board, and wherein the rolling section is received in the holder, and wherein the mounting section is wrapped around the second spindle.

20. The turn-over structure of a multimedia device of claim 18, wherein the mounting section and the second connecting section are connected by a titled section, and wherein the second connecting section is connected with the host.
